(19) United States
(12) Patent Application Publication
(10) Pub. No.: US 2007/0137405 A1
(43) Pub. Date: Jun. 21, 2007

(54) PARKBRAKE RELEASE MECHANISM AND METHOD OF USE

(76) Inventors: Ryan M. Pereira, Rochester Hills, MI (US); Vladimir Krupin, Clarkston, MI (US); Daniel Raikes, Warren, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/560,605

(22) Filed: Nov. 16, 2006

Related U.S. Application Data
(60) Provisional application No. 60/738,260, filed on Nov. 18, 2005.

(51) Int. Cl. G05G 5/06

(52) U.S. Cl. 74/529

(57) ABSTRACT

A parking brake release mechanism includes a brake handle having a longitudinal axis. A release cable is disposed at least partially in the brake handle and a push button actuator is positioned to be accessed from a tip of the handle for actuating the release cable. The push button actuator preferably moves lineally with respect to the longitudinal axis of the handle for locking and unlocking the brake component. The release cable is flexible and biased between two positions to form a push-pull cable actuator.

### RELATED APPLICATION

This application claims priority of U.S. Provisional Patent Application Ser. No. 60/738,260 filed Nov. 18, 2005, which is incorporated herein by reference.

### FIELD OF THE INVENTION

The invention relates to park brake release mechanisms.

### BACKGROUND OF THE INVENTION

Park brake release mechanisms are known in the art. Typical release mechanisms include pull release mechanisms where an operator pulls a handle attached to a cable to unlock a park brake that has been engaged. Another known release mechanism includes a hand lever type release that is moved about a pivot to engage and disengage the park brake. The lever includes a button that is depressed to allow movement of the lever to engage and disengage the park brake.

Such brake levers include rod linkages coupled to the button to actuate the release mechanism and allow an operator to move the lever. The rod mechanisms contribute to the overall cost and complexity of a release mechanism, as well as adversely affect the packaging size and configuration of a release mechanism. Additionally, rod actuated release mechanisms may adversely affect the noise vibration and harshness of the release mechanisms.

There is therefore a need in the art for a release mechanism that eliminates the need for complex rod linkages and has an improved noise vibration and harshness performance. There is also a need in the art for a release mechanism that has a push button release that moves lineally with respect to a release cable allowing connection to a cable directly. Also, there is a need in the art for a release mechanism that is cost effective and can be used on a variety of park brake systems. Finally, there is a need in the art for a release mechanism that improves the packaging of such systems and can be used on various brake levers, brake pedals and vehicle mounted push button release applications.

### SUMMARY OF THE INVENTION(S)

In a first aspect there is disclosed a parking brake release mechanism that includes a release cable including a strand having first and second portions. A release actuator is connected at the first portion of the strand. A brake component is connected to the second portion of the strand. The release actuator is positioned and connected to the strand to move lineally relative to the strand for locking and unlocking the brake component.

In a second aspect there is disclosed a parking brake release mechanism that includes a brake handle having a longitudinal axis. A release cable is disposed at least partially in the brake handle and a push button actuator is positioned to be accessed from a tip of the handle for actuating the release cable. The push button actuator maybe connected to the first portion of the strand. A brake component maybe coupled to the second portion of the strand. The push button actuator preferably moves lineally with respect to the longitudinal axis of the handle for locking and unlocking the brake component. In a preferred embodiment the strand is flexible and biased between two positions to form a push-pull cable actuator.

In a third aspect there is disclosed a parking brake release mechanism that is moveable between locked and unlocked positions. The parking brake release mechanism includes a release cable including a strand having first and second portions. A release actuator is coupled to the first portion of the strand. The release actuator includes a first biasing member biasing the parking brake release mechanism to the locked position. A brake component is coupled to the second portion of the strand. The brake component includes a second biasing member biasing the parking brake release mechanism to the unlocked position. The first biasing member has a greater biasing force than the second biasing member such that the parking brake release mechanism is biased toward the locked position until an external force is applied to the first biasing member allowing movement of the strand toward the unlocked position in response to the biasing force of the second biasing member.

### BRIEF DESCRIPTION OF THE DRAWINGS

FIG. 1 is an exploded perspective view of a brake assembly including the park brake release mechanism of the present invention;

FIG. 2 is a partial perspective view of a release actuator in the locked position;

FIG. 3 is a perspective view of a release actuator in the unlocked position;

FIG. 4 is a perspective view of a release actuator without the release housing detailing engagement of the first spring with the release member;

FIG. 5 is a perspective view of a brake component including a pawl and sector in the locked position;

FIG. 6 is a perspective view of a brake component including a pawl and sector in the unlocked position;

FIG. 7 is a perspective view of an alternative embodiment of a release mechanism having a brake handle having an integrally formed release housing;

FIG. 8 is a side view alternative embodiment of a brake component including a pawl and sector;

FIG. 9 is a perspective view alternative embodiment of a brake component including a pawl and sector;

FIG. 10 is a perspective view of an alternative embodiment of a release mechanism having an integral push button and release member;

FIG. 11 is a perspective view of the cable strand and release member of FIG. 10;

FIG. 12 is a perspective view of an alternative embodiment of a release mechanism having a push button and clutch actuated brake;

FIG. 13 is a block diagram of a parking brake assembly.

### DETAILED DESCRIPTION OF THE PREFERRED EMBODIMENTS

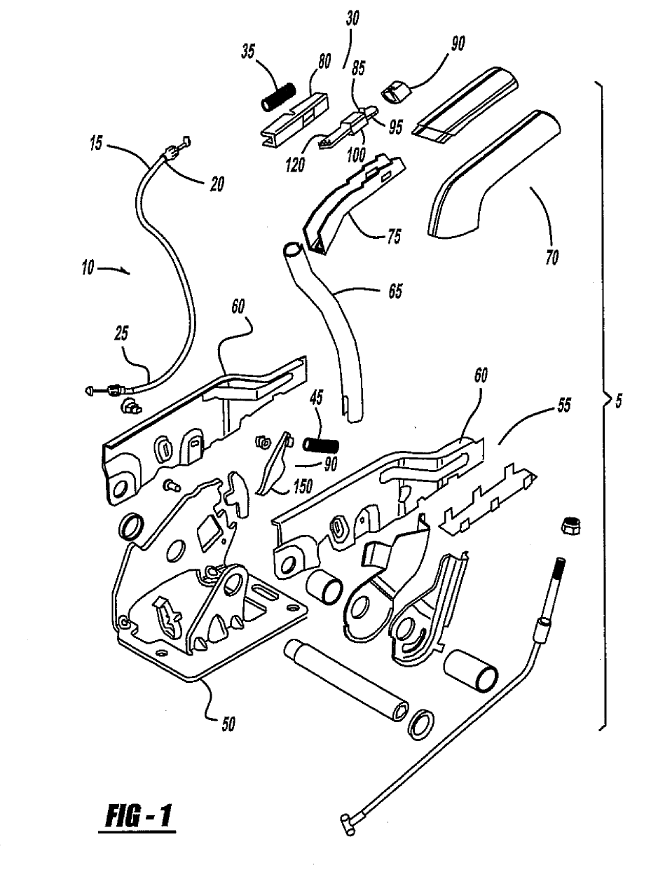

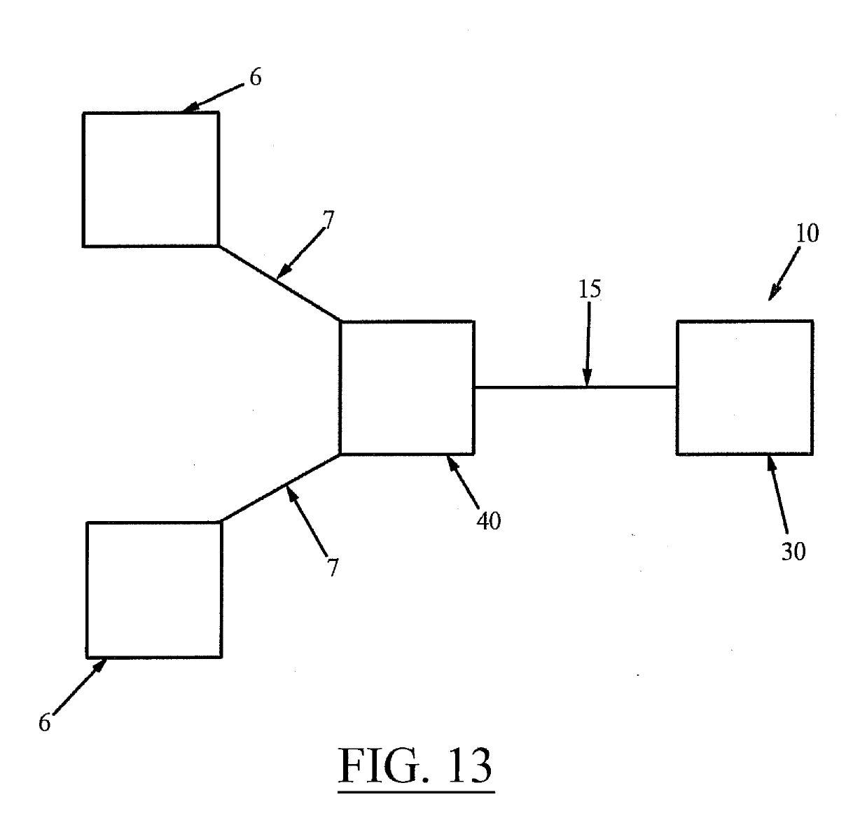

Referring to FIGS. 1 and 13, there is shown one embodiment of a brake assembly 5 including a parking brake release mechanism 10. The parking brake assembly 5 includes a main actuator assembly, such as a main cable 7 which controls a brake on a wheel 6 of a vehicle. This main cable 7 is distinguished from a release cable 15 that is not directly linked with the brake on a wheel 6, but is associated with a release mechanism 10.

The parking brake release mechanism 10 is movable between locked and unlocked positions and includes a release cable 15 having a strand 17 having first and second portions 20, 25. A release actuator 30 is coupled to the first portion 20 of the strand 17 and moves lineally with respect to the strand 17. A brake component 40 is coupled to the second portion 25 of the strand 17.

A first biasing member 35 positioned at the first portion 20 of the strand 17, with a spring being shown although other biasing members may be utilized, biases the parking brake release mechanism 10 to the locked position. A second biasing member 45, with a spring being shown although other biasing members may be utilized, is positioned at the second portion of the strand 17 and biases the parking brake release mechanism 10 to the unlocked position. The first biasing member 35 has a greater biasing force than the second biasing member 45 such that the parking brake release mechanism 10 is biased toward the locked position until an external force is applied to the first biasing member 35 allowing movement of the strand 17 toward the unlocked position in response to the biasing force of the second biasing member 45.

One embodiment of the brake assembly 5, as detailed in FIG. 1 includes a mounting bracket 50 that is attached to a vehicle body. As shown, the embodiment is a hand brake; however, such a system could be modified to be a footbrake. A brake handle assembly 55 including a handle housing 60 is pivotally attached to the mounting bracket 50. The handle assembly has a longitudinal axis and includes a tube 65 connected to the handle housing 60. A handle grip 70 is disposed on an upper portion of the handle tube 65. The handle grip 70 includes a grip housing 75 disposed within the grip 70 and coupled to the handle tube 65. The handle grip 70 also includes a tip at the end of the handle grip.

The parking brake release mechanism 10 includes the release cable 15 at least partially disposed within the handle grip 70 and handle tube 65. As stated above, the release cable 15 includes a strand 17 having a first portion 20 coupled to the release actuator 30 and a second portion 25 coupled to the brake component 40.

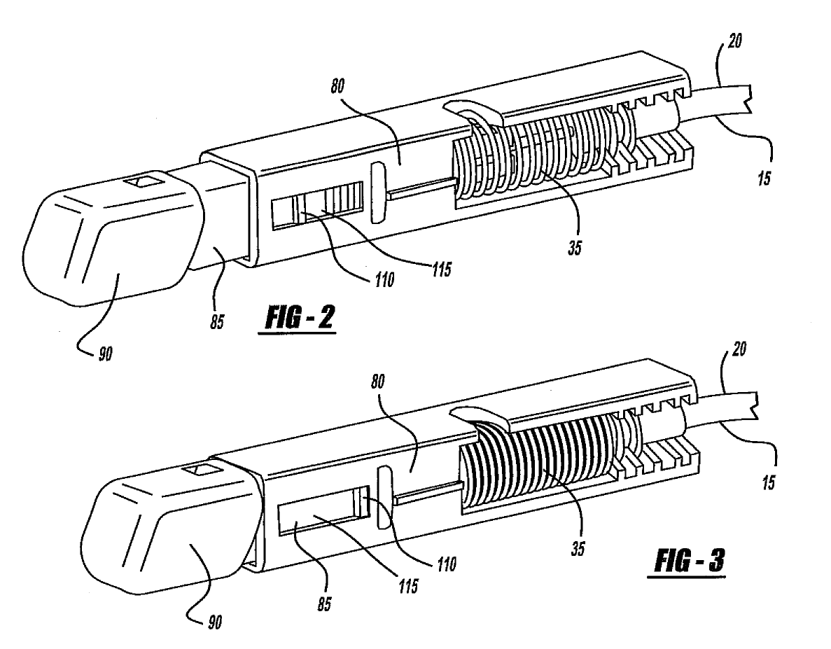

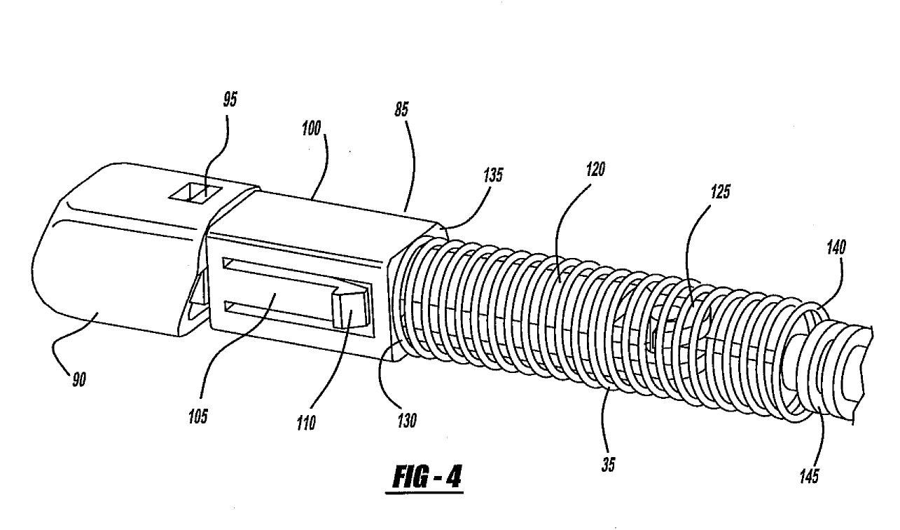

Referring to FIGS. 2 and 3, there is shown one embodiment of a release actuator 30 that may be utilized by the present invention. The release actuator 30 includes a release housing 80 disposed within the grip housing 75. A release member 85 is positioned within the release housing 80 and is capable of movement longitudinally within the release housing 80. The first biasing member 35 is positioned about the release member 85 and biases the release member 85 toward the locked position, as shown in FIG. 2. The release actuator 30 may also include an end cap 90 positioned about a first portion 95 of the release member 85 that may be depressed by an operator of the vehicle to compress the first biasing member 35. The end cap 90 may alternatively be a push button as will be described in more detail below.

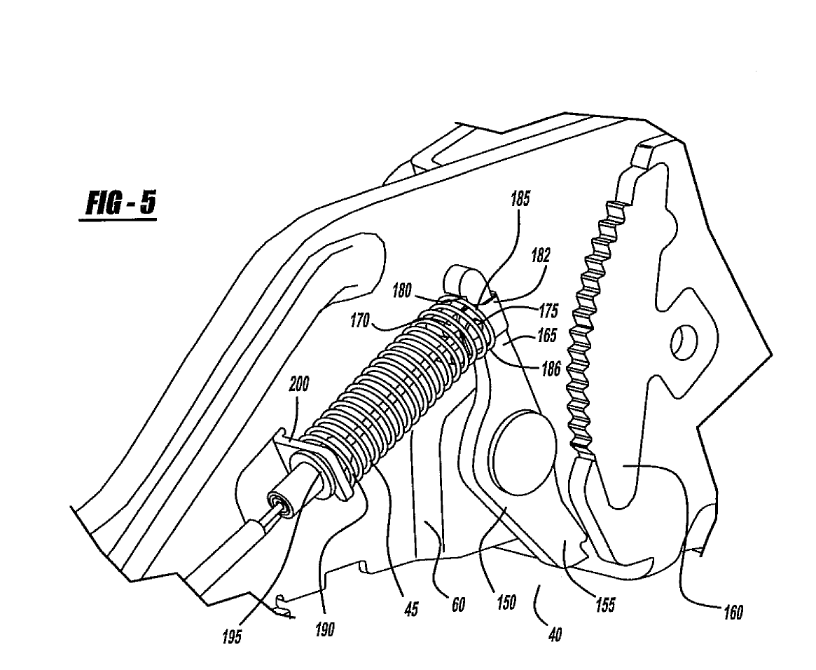

Referring to FIG. 4, there is shown the release member 85 and first biasing member 35 without the release housing 80. The release member 85 includes a first portion 95 that is adapted to engage the end cap 90, as described above. The first portion 95 of the release member 85 also includes a guide portion 100 having a rectangular cross section in the pictured embodiment although other shapes may be utilized. The guide portion 100 also includes a spring arm 105 having a stop 110 that is received within a notch 115 formed in the release housing 80, as best shown in FIGS. 2 and 3. The stop 110 travels within the notch 115 and limits the amount of travel of the release member 85 within the release housing 80 to prevent excess compression of the first biasing member 35, as well as determine the amount of travel of strand 17. The release member 85 also includes a biasing member engaging portion 120 extending longitudinally from the guide portion 100. The biasing member engaging portion 120 includes a second portion 125 that is adapted to engage a fitting associated with the first portion 20 of the strand 17.

As can be seen in FIG. 4, the first biasing member 35 is positioned about the biasing member engaging portion 120 of the release member 85. The first biasing member 35 includes a first portion 130 that abuts a face 135 defined by the transition from the guide portion 100 to the biasing member engaging portion 120 of the release member 85. The second portion 140 of the first biasing member 35 abuts an end face of one of a series of separated walls 126 formed on the interior of the release housing 80. The first biasing member 35 biases the release member 85 toward the locked position shown in FIG. 2.

As best seen in FIGS. 2 and 3, the series of separated walls 126 define notches 128 tat engage a conduit fitting 145 positioned at the first portion 20 of the release cable 15. The series of separated walls 126 allow the conduit fitting 145 to be adjusted to different positions to adjust the length of the cable 15. The conduit fitting 145 may be positioned in any of the notches 128 to take up or pay out the cable 15 as needed.

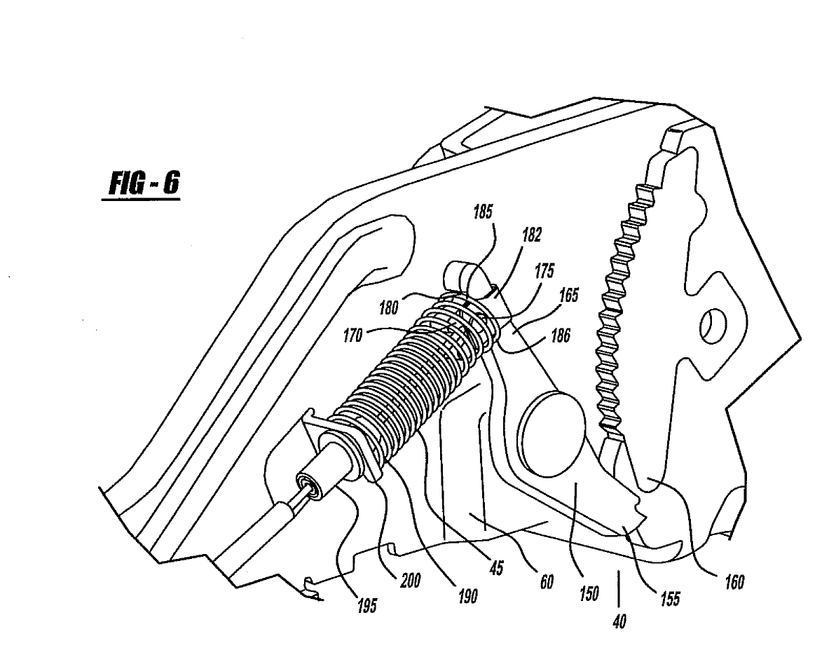

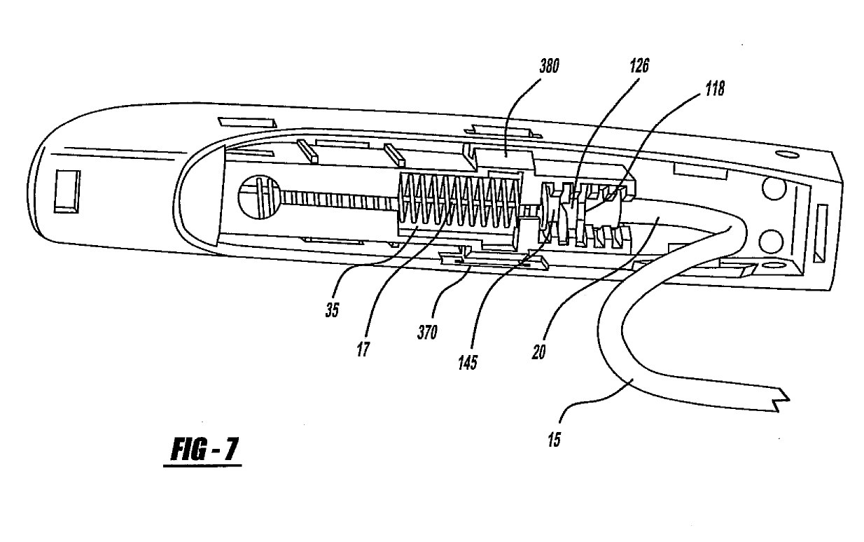

The parking brake release mechanism 10 may also include a brake component 40, detailed in FIGS. 5 and 6, that is coupled to the second portion 25 of the strand 17. The brake component 40 in the depicted embodiment includes a pawl 150 that is pivotally coupled to the handle housing 60. The pawl 150 includes a first portion 155 that is adapted to engage a sector 160 connected with the mounting bracket 50. The pawl 150 also includes a second portion 165 that includes a connection portion 170 that is sized and shaped to engage an end fitting 175 associated with the second portion 25 of the strand 17. In one aspect, the end fitting 175 is received within the connection portion 170 and a retainer clip 182 is positioned about the pawl 150 and engages the end fitting 175 to securely retain the end fitting 175 within the connection portion 170 of the pawl 150. It should be realized that alternative structures for attaching the strand 17 to the pawl 150 may be utilized. The pawl 150 also includes a pair of notches 180 formed about the connection portion 170 that are sized and positioned to allow the second biasing member 45 to seat against the pawl 150 at a first portion 185 of the second biasing member 45. As can be seen in FIGS. 5 and 6, the second biasing member 45 is disposed about the connection portion 170 of the pawl 150 and is seated within the notches 180 formed on the pawl 150 at a first portion 185 of the second biasing member 45. A second portion 190 of the second biasing member 45 engages a cable fitting 195 associated with the second portion 25 of the release cable 15 or alternatively could associate with any fixed flange or surface. The cable fitting 195 is fixed using any suitable structure. In the depicted embodiment, the cable fitting 195 is mounted on a tab 200 that extends from the handle housing 60. In this manner, the second biasing member 45 is retained and applies a biasing force to the pawl 150 for pivotal movement of the pawl 150 about the handle housing 60.

In use, an operator presses on the end cap 90 causing the release member 85 to travel within the release housing 80 a specified distance, as determined by the length of the notch 115 formed in the release housing 80 that engages the tab 110 formed on the release member 85. As a result of movement of the release member 85 from the locked position shown in FIG. 2 to the unlocked position shown in FIG. 3, the first biasing member 35 is compressed allowing movement of the strand 17 against the otherwise present biasing force of the first biasing member 35.

At the second portion 25 of strand 17, the second biasing member 45 is compressed in the locked position, as shown in FIG. 5, due to the greater force of the first biasing member pulling the strand 17 toward the first portion 20 and causing pivotal movement of the pawl 150 such that it engages the sector 160 preventing pivotal movement of the handle housing 60 about the mounting bracket 50. When the release member 85 is moved from the locked position shown in FIG. 2 to the unlocked position shown in FIG. 3, the second biasing member 45 is then free to expand, as shown in FIG. 6, causing pivotal movement of the pawl 150 with respect to the handle housing 60. In this manner, the pawl 150 disengages the sector 160 allowing for pivotal movement of the handle housing 60 about the mounting bracket 50. As stated above, the balance of spring forces where the first biasing member 35 has a greater biasing force than the second biasing member 45 allows for the release mechanism 10 to be maintained in the locked position until an external force is applied compressing the first biasing member 35 and allowing the stored energy within the second biasing member 45 to pivot the pawl 150 away from the sector 160 allowing pivotal movement of the handle housing 60 with respect to the mounting bracket 50.

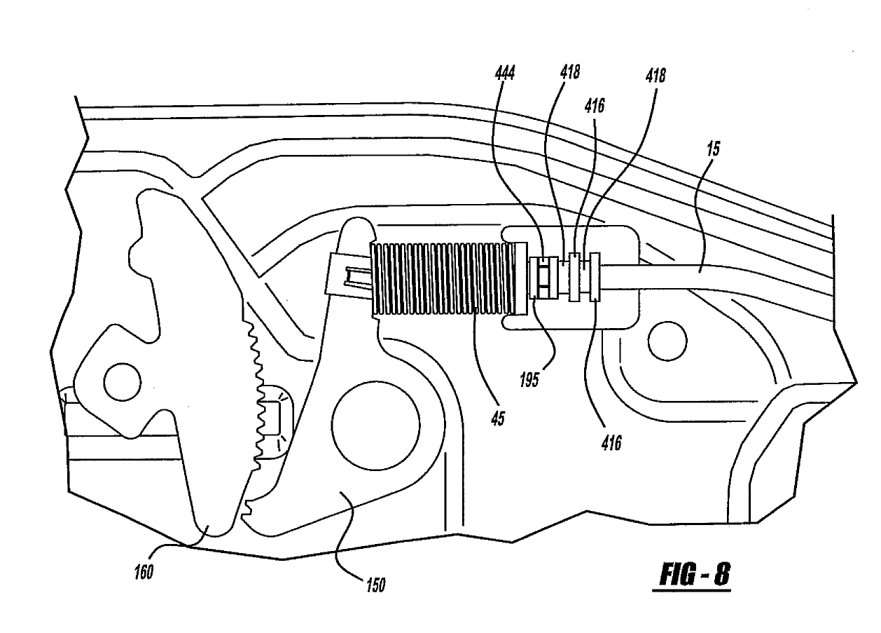

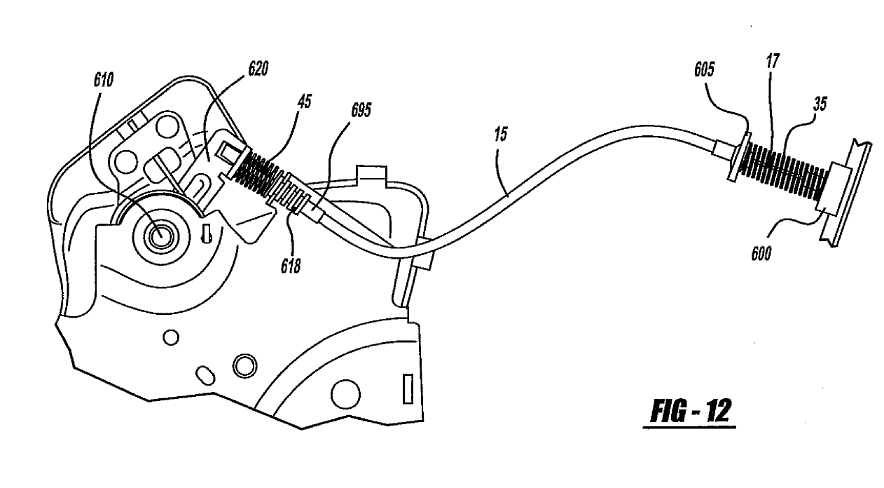

In an alternative embodiment shown in FIG. 7, the handle grip 370 may include an integrally formed release housing 380. Similar to the above described embodiment, the release actuator moves lineally with respect to the strand 17. As with the previously described embodiment, the release housing 380 may include the series of separated walls 126 defining notches 128 that engage a conduit fitting 145 positioned at the first portion 20 of the release cable 15 or the release housing 380 may include a single notch for attaching to the conduit fitting 145. However, the release member 385 may be of a different configuration than that previously described. The release member 385 may be similar to that depicted in FIG. 11. The release member 385 shown in FIG. 11 includes a push button portion 390 and a guide portion 300. The first portion 20 of the strand 17 is connected to the guide portion 300 of the release member 385. The first biasing member 35 associates with an end face 340 of the release member 385 at the first portion of the biasing member 35 and associates with a face of the series of separated walls 126 at a second portion of the biasing member 35. The strand 17 passes through the biasing member 35 to connect with the guide portion 300. The alternative embodiment operates in the same manner as that described above.

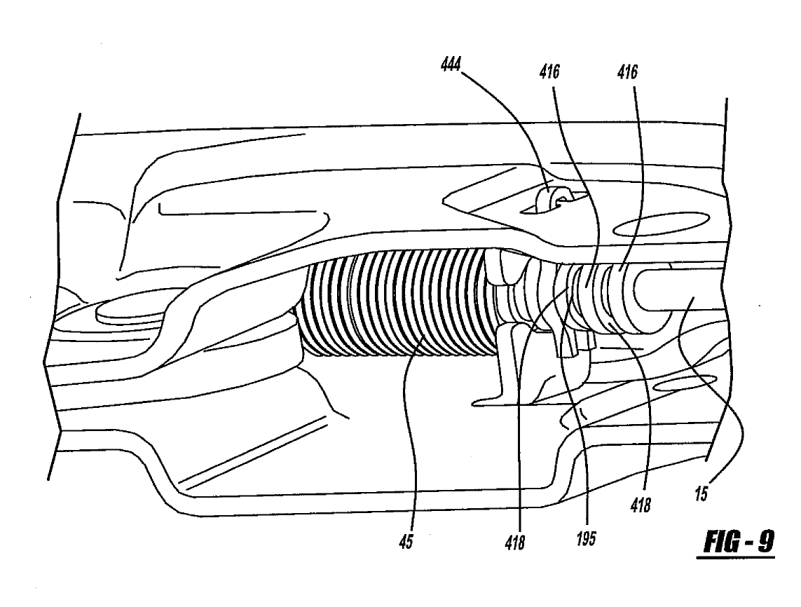

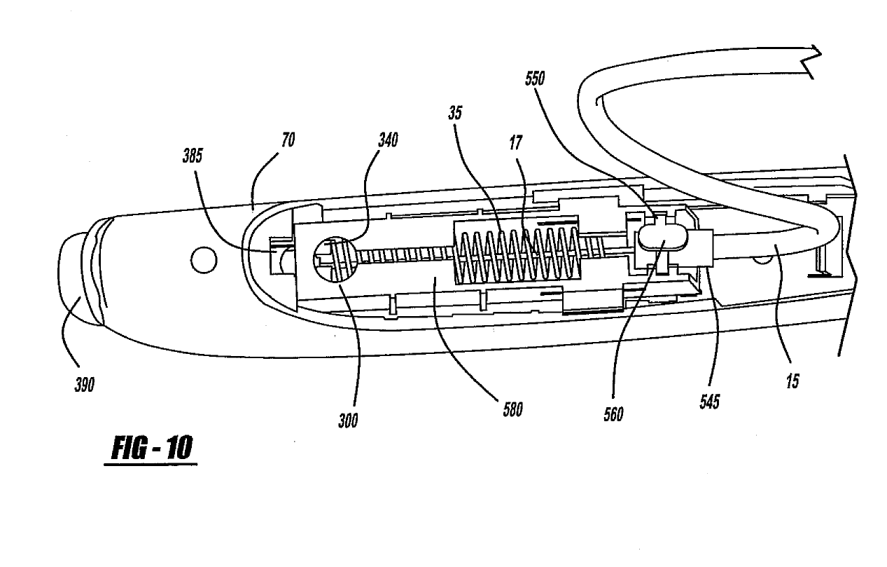

Another alternative embodiment of a release mechanism 10 is shown in FIGS. 8 and 9. In the depicted embodiment the cable end fitting 195 is at the second portion 25 of the strand 17 associated with the brake component 40. As with the previously described embodiment the brake component 40 may include a pawl 150 and sector 160. The second biasing member 45 acts as above and biases the pawl 150 out of engagement from the sector 150 when a force is applied overcoming the first biasing member 35. The second biasing member 45 is seated on the pawl 150 and the end fitting 195, as described above. However, the end fitting 195 includes a series of separated walls 416 that define notches 418. A fixed clip 444, as best shown in FIG. 9 can engage different notches 418 to adjust a length of the cable 15. The series of notches 418 may be used with or with out the series of notches 118 described above at the first portion 20 of the strand 17 to adjust the cable length at either portion of the cable 15.

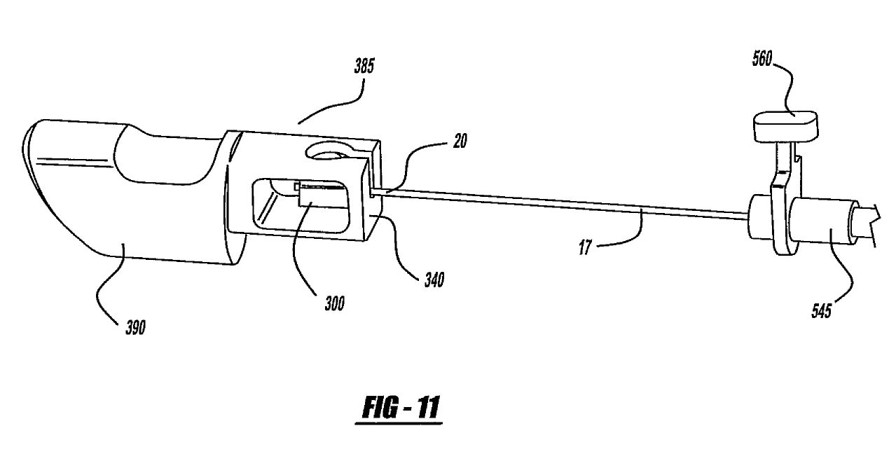

Another alternative embodiment is shown in FIGS. 10 and 11. The release housing 580 is similar to that described above in FIG. 7 except that it is not integrally formed with the handle 70. The release member 385 is the same as that described above with the respect to FIG. 11 and includes a push button portion 390 and a guide portion 300. The first portion 20 of the strand 17 is connected to the guide portion 300 of the release member 385. The first biasing member 35 associates with an end face 340 of the release member 385 at the first portion of the biasing member 35 and associates with an end face of the release housing 580 at the second portion of the first biasing member 35. The embodiment shown in FIG. 10 includes a single notch 550 formed in the release housing 580 to receive a conduit end fitting 545. The conduit end fitting 545 includes a contact portion 560 for pushing it into the notch 550.

Referring to FIG. 12 there is shown another alternative embodiment. The release actuator 30 is a push button actuator that is disposed on a surface of a vehicle. In one aspect the push button 600 may be positioned on a control panel of a vehicle. The first portion of the strand 17 is connected to the push button 600. A first biasing member 35 associates with the push button 600 at a first portion of the first biasing member 35 and associates with an engagement surface 605 at a second portion of the first biasing member 35 for moving the release mechanism 10 to a locked position. The brake component 40 includes a clutch 610 moveable to lock and unlock the release mechanism 10. The clutch 610 includes a lever 620 connected to the second portion of the strand 17. The second portion of the cable includes a fixedly retained conduit fitting 695 similar to that described above. A second biasing member 45 has a first portion associating with the lever 620 and a second portion associating with a face of the conduit end fitting 695 for moving the release mechanism 10 to the unlocked position. As with the previously described embodiment of FIGS. 8 and 9 a length of the cable can be adjusted by positioning in various notches 618 formed in the conduit fitting 695.

While the parking brake release mechanism 10 has been described with respect to various brake assemblies including a pawl 150 that engages a sector 160, other parking brake designs may be utilized with the release mechanism 10 of the present invention. For example, the parking brake release mechanism 10 having a first biasing member 35 having a greater biasing force than a second biasing member 45 disposed on opposing portions of a release cable 15 may be used on both self adjust and manual adjust designs, as well as torsion lock designs. U.S. Pat. Nos. 5,588,335; 5,309,786; 5,832,784; 5,907,977 disclose torsion lock designs and are commonly owned by the assignee of the present application and are herein incorporated by reference. The torsion lock design may utilize a release cable 15 in the same manner described with respect to the pawl 150 and sector 160 design disclosed above. In such a design, the first biasing member 35 again would have a greater force than a second biasing member 45 associated with the torsion lock of the brake assembly. In such a design, an external force exceeding the first biasing member 35 would need to be applied to allow the biasing force of the second biasing member 45 to release the torsion lock allowing for actuation of a parking brake.

The invention has been described in an illustrative manner. It is to be understood that the terminology which has been used is intended to be in the nature of words of description rather than limitation. Many modifications and variations of the invention are possible in light of the above teachings. Therefore, within the scope of the appended claims, the invention may be practiced other than as specifically described.

1. A parking brake release mechanism moveable between locked and unlocked positions comprising:
a release cable including a strand having first and second portions;
a brake handle assembly having a longitudinal axis, a handle portion and a tip
a push button actuator positioned to be accessed from the tip of the brake handle assembly along the longitudinal axis, the push button actuator connected to the first portion of the strand to move lineally with respect to the strand, the push button actuator including a first biasing member to move the parking brake release mechanism to the locked position;
a brake component coupled to the second portion of the strand, the brake component including a second biasing member to move the parking brake release mechanism to the unlocked position;
wherein the first biasing member has a greater biasing force than the second biasing member such that the parking brake release mechanism is biased toward the locked position until an external force is applied to the first biasing member allowing movement of the strand toward the unlocked position in response to the biasing force of the second biasing member.

2. The parking brake release mechanism of claim 1 wherein the push button actuator includes a push button portion and a guide portion, and a biasing member engaging portion extending longitudinally from the guide portion.

3. The parking brake release mechanism of claim 2 wherein the first biasing member associates with an end face of the guide portion at a first portion of the biasing member and associates with an end face of the release housing at a second portion of the biasing member for moving the release mechanism to the locked position.

4. The parking brake release mechanism of claim 2 wherein the guide portion includes a stop for regulating the amount of travel of the strand.

5. A parking brake release mechanism comprising:
a release cable including a strand having first and second portions;
a release actuator connected to the first portion of the strand;
a brake component connected to the second portion of the strand;
the release actuator positioned to move lineally with respect to the strand for locking and unlocking the brake component.

6. The parking brake release mechanism of claim 5 wherein the release cable is flexible and biased between two positions to form a push-pull cable actuator.

7. The parking brake release mechanism of claim 5 including a first biasing member associated with the first portion of the strand and a second biasing member associated with the second portion of the strand, wherein the first biasing member applies a greater biasing force to the strand than the second biasing member such that the parking brake release mechanism is biased toward a locked position until an external force is applied to the first biasing member allowing movement of the strand toward an unlocked position in response to a biasing force of the second biasing member.

8. The parking brake release mechanism of claim 5 wherein the release actuator is disposed in a handle assembly.

9. The parking brake release mechanism of claim 8 wherein the release actuator is a push button actuator positioned proximate an end of the brake handle assembly along a longitudinal axis of the brake handle assembly.

10. The parking brake release mechanism of claim 5 wherein the release actuator is a push button actuator disposed on a control panel of a vehicle.

11. The parking brake release mechanism of claim 10 including a first biasing member associated with the push button at a first portion of the biasing member and associated with an engagement surface at a second portion of the biasing member for moving the release mechanism to a locked position.

12. The parking brake release mechanism of claim 5 wherein the brake component includes a clutch moveable to lock and unlock the release mechanism.

13. The parking brake release mechanism of claim 12 including a second biasing member having a first portion associated with the lever and a fixed second portion for moving the release mechanism to the unlocked position.

14. The parking brake release mechanism of claim 5 wherein the brake component includes a pawl pivotal about a housing.

15. The parking brake release mechanism of claim 5 including a conduit fitting having a series of separated walls formed on the conduit fitting and a retained clip, the retained clip engaging different notches defined by the series of separated walls for adjusting a length of the cable.

16. The parking brake release mechanism of claim 14 including a second biasing member having a first portion associated with the pawl and a fixed second portion for moving the release mechanism to an unlocked position.

17. A parking brake release mechanism comprising:
a release cable including a strand having first and second portions;
a brake handle assembly having a longitudinal axis, a handle portion and a tip
a push button actuator positioned to be accessed from the tip of the brake handle assembly along the longitudinal axis, the push button actuator connected to the first portion of the strand;
a brake component coupled to the second portion of the strand;
the push button actuator moving lineally with respect to the handle for locking and unlocking the brake component.

18. The parking brake release mechanism of claim 17 wherein the release cable is flexible and biased between two positions to form a push-pull cable actuator.

19. The parking brake release mechanism of claim 17 wherein the release member includes a push button portion and a guide portion and wherein a first biasing member associates with an end face of the guide portion at a first portion of the biasing member and associates with an end face of the release housing at a second portion of the first biasing member for moving the release mechanism to the locked position.

20. The parking brake release mechanism of claim 19 wherein the guide portion includes a stop for regulating the amount of travel of the strand.

21. The parking brake release mechanism of claim 19 wherein the release member includes a biasing member engaging portion extending longitudinally from the guide portion.

22. The parking brake release mechanism of claim 21 wherein the first biasing member is disposed about the biasing member engaging portion.

23. A parking brake release mechanism moveable between locked and unlocked positions comprising:
a release cable including a strand having first and second portions;
a release actuator coupled to the first portion of the strand, the release actuator including a first biasing member associated with the first portion of the strand biasing the parking brake release mechanism to the locked position;
a brake component coupled to the second portion of the strand, the brake component including a second biasing member associated with the second portion of the strand biasing the parking brake release mechanism to the unlocked position;
wherein the first biasing member has a greater biasing force than the second biasing member such that the parking brake release mechanism is biased toward the locked position until an external force is applied to the first biasing member allowing movement of the strand toward the unlocked position in response to the biasing force of the second biasing member.

24. The parking brake release mechanism of claim 23 wherein the release cable is flexible and biased between two positions to form a push-pull cable actuator.

25. The parking brake release mechanism of claim 23 wherein the release actuator includes a brake handle assembly having a longitudinal axis, a handle portion and a tip and a push button actuator positioned to be accessed from the tip of the brake handle assembly along the longitudinal axis, the push button connected to the first portion of the strand.

26. The parking brake release mechanism of claim 23 wherein the release actuator is a push button actuator disposed on a control panel of a vehicle.

27. The parking brake release mechanism of claim 26 wherein the first biasing member is associated with the push button at a first portion of the biasing member and associated with an engagement surface at a second portion of the first biasing member for moving the release mechanism to the locked position.

28. The parking brake release mechanism of claim 23 wherein the brake component includes a clutch moveable to lock and unlock the release mechanism.

29. The parking brake release mechanism of claim 23 wherein the brake component includes a pawl pivotal about a housing.
